(19) United States
(12) Patent Application Publication
(10) Pub. No.: US 2024/0253573 A1
(43) Pub. Date: Aug. 1, 2024

(54) Conduit Carrier Retriever

(71) Applicant: Andrew Bradley Ranallo, George Town, TX (US)

(72) Inventor: Andrew Bradley Ranallo, George Town, TX (US)

(21) Appl. No.: 18/102,628

(22) Filed: Jan. 27, 2023

(51) Int. Cl. B60R 9/042; B60R 9/048

(52) U.S. Cl. CPC B60R 9/042; B60R 9/048

(57) ABSTRACT

A conduit carrier retriever for accessing contents of a storage pipe, composed of materials which offer a bumper plate for dangerous shifting materials during emergency braking.

### CROSS-REFERENCE TO RELATED APPLICATION

The present application is to be used in conjunction with similar systems as US Patent filing US20070108351A1.

### BACKGROUND OF THE INVENTION

### 1. Field of the Invention

The present invention relates generally to retrieval of hard to reach stowed items in roof rack mounted pipe carrier systems, which are used commonly in the construction trades.

### 2. Background of the Related Art

In the construction trades it is common to use a section of large pipe (typically four or six inches in diameter and 10 feet in length) as a storage vessel or container for other smaller pipe used at construction sites.

When short lengths of pipe are stowed in the storage container they become a nuisance to access. Also on heavy braking of a vehicle the heavy pipe segments can compromise the front cap and break through in traffic resulting in catastrophic events.

To solve this problem tradesmen store the smaller segments of pipe in a different location rendering the storage container obsolete.

Therefore there is a need for a quick easy method of retrieval for the unreachable stowed items, and a barrier for shifting pipe during emergency braking.

Therefore there is a need for a quick easy method of retrieval for the unreachable stowed items, and a barrier for shifting pipe during emergency braking.

### SUMMARY OF THE INVENTION

The present invention solves the problems of the prior art by providing a bulkhead type plug inserted into the closed end of the empty storage pipe with an accessible handle from the opening end.

Effectively, creating a movable back stop to bring all of the stored items to an accessible distance.

Another provision of the present invention is a conduit carrier retriever that can be easily removed if desired.

### BRIEF DESCRIPTION OF THE DRAWINGS

These and other features, aspects, and advantages of the present invention will become better understood with reference to the following description, appended claims, and accompanying drawings where:

FIG. 1 is a perspective view of the conduit carrier retriver of the present invention;

FIG. 2 is a front elevation view thereof;

FIG. 3 is a side elevation view thereof; in place inside the storage pipe;

FIG. 4 is a rear view thereof;

### DETAILED DESCRIPTION OF INVENTION

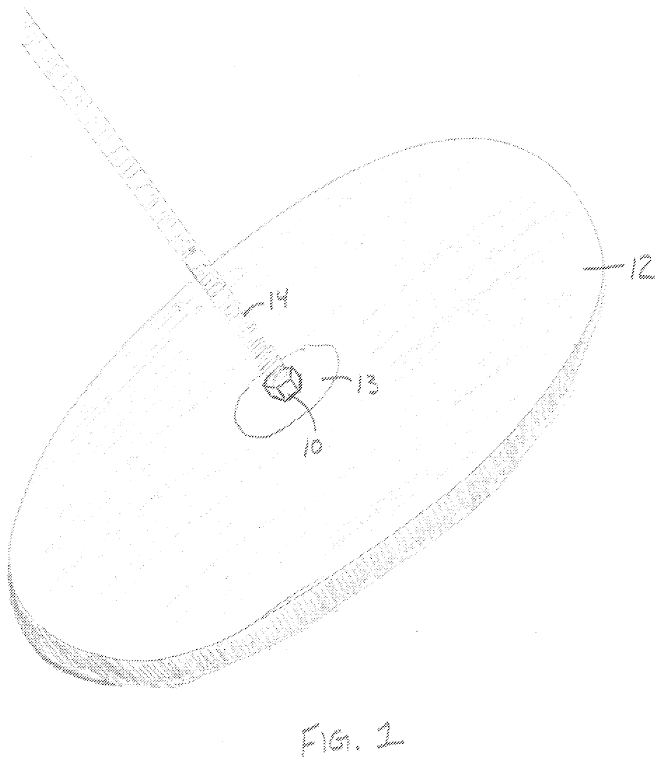

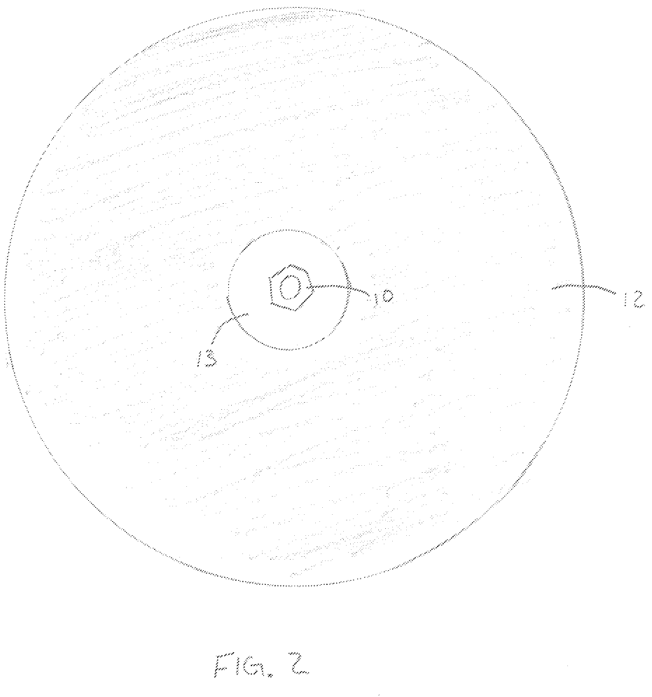

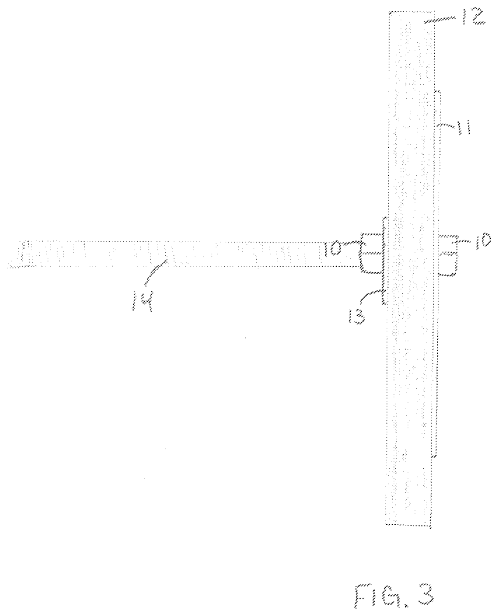

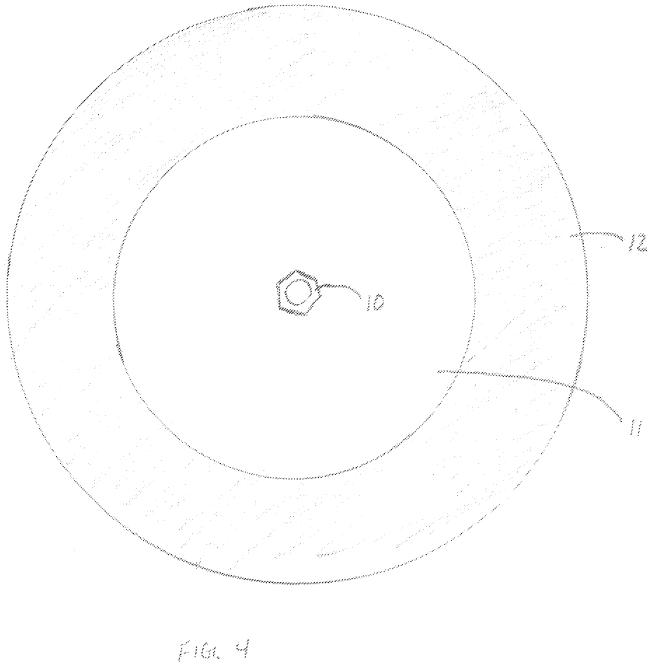

Referring to FIGS. 1-4, the conduit carrier retriever of the present invention consists of a series of disks stacked to maintain a malleable yet rigid balance. This combination ensures durability and performance. The first disk is made of three quarter inch thick vulcanized rubber shown at 12. The backplate is a three inch fender washer with a three eights central hole shown at 11. The front washer is a three inch fender washer with a three eights central hole shown at 13. To hold the disks together there are two three eights nuts on the outside of each washer shown at 10. These two are threaded onto a piece of three eights all-thread that is ten feet long to act as the handle shown at 14. To illustrate the placement of the conduit carrier retriever the conduit carrier pipe is shown in FIG. 3 at 15.

This unique set up offers an impact resistant bumper plate. While also accounting for small variances in pipe diameter due to compression of the carrier by clamps and warpage from solar radiation.

Therefore, it can be seen that the present invention provides a unique solution to the problem of retrieving hard to reach items stored in a conduit carrier. As well as providing a safe bumper to reduce frontal impacts on the caps.

It would be appreciated by those skilled in the art that various changes and modifications can be made to the illustrated embodiments without departing from the spirit of the present invention. All such modifications and changes are intended to be within the scope of the present invention except as limited by the appended claims.

1. A conduit carrier retriever for accessing hard to reach items stored in a storage pipe, comprising:
A bulkhead plate with an attachable handle used for maneuvering contents of a storage pipe.

2. The article of claim 1, wherein said bulkhead plate comprises:
Consists of a rigid material used for moving contents.

3. The article of claim 2, wherein said a bulkhead plate consists of rigid material, comprising: Impact resistant material.
